(19) United States
(12) Patent Application Publication
(10) Pub. No.: US 2025/0330553 A1
(43) Pub. Date: Oct. 23, 2025

(54) SYSTEM AND METHOD FOR FRAME RATE CONTROL AND PRIORITY FRAME PROCESSING FOR 3D RENDERING

(71) Applicant: Board of Regents, The University of Texas System, Austin, TX (US)

(72) Inventor: Wei Wang, San Antonio, TX (US)

(21) Appl. No.: 19/186,550

(22) Filed: Apr. 22, 2025

Related U.S. Application Data
(60) Provisional application No. 63/636,929, filed on Apr. 22, 2024.

(51) Int. Cl. H04N 7/01; G06T 1/20; G06T 9/00

(52) U.S. Cl. CPC H04N 7/013; G06T 1/20; G06T 9/00

(57) ABSTRACT

Embodiments are directed to a computer-implemented method for regulating graphics frame rendering and encoding rates. The method including synchronizing a frame rate of rendering graphics frames by a 3D application executing in a cloud server with a frame rate of encoding rendered graphics frames at a proxy server; and synchronizing the frame rate of encoding the rendered graphics frames at the proxy server with a frame rate of transmitting the encoded graphics frames to a client device over a network.

### RELATED APPLICATION

This Application is a US Utility Application claiming priority to U.S. Provisional Patent Application 63/636,929 filed Apr. 22, 2024 which is incorporated herein by reference in its entirety.

### FIELD

The present disclosure relates generally to frame rate control for video rendering, and in particular to a system and method for frame rate control and priority frame processing for cloud-based 3D rendering.

### BACKGROUND

The convergence of cloud computing and virtual reality (VR) technology has unlocked unprecedented possibilities in the realm of gaming and interactive entertainment. Cloud-based 3D VR gaming represents a groundbreaking paradigm shift, offering immersive experiences that transcend the limitations of traditional gaming platforms. By leveraging the power of cloud infrastructure, users can access high-fidelity 3D environments, richly detailed worlds, and seamless interactive gameplay from virtually any device with an internet connection.

Cloud-based 3D VR gaming eliminates the need for expensive gaming hardware and complex installations, democratizing access to cutting-edge gaming experiences. With just a VR headset and an internet-enabled device, players can immerse themselves in virtual worlds. Further, the scalability and flexibility of cloud infrastructure enable developers to push the boundaries of creativity and innovation in game design.

### BRIEF DESCRIPTION OF THE DRAWINGS

FIG. 1 is a simplified block diagram of a typical cloud 3D system;

FIG. 2 is a simplified diagram illustrating the not insignificant frame rate gap between what is provided by a state-of-the-art cloud data center and the rate of decoded frames at the client device;

FIG. 3 is a simplified block diagram of an embodiment of a cloud 3D system with frame rate control and priority frame processing according to the teachings of the present disclosure;

FIGS. 4A-4F illustrate the double buffer swapping and synchronization method deployed at the interface between the 3D application and proxy server and at the interface between the proxy server and the network according to the teachings of the present disclosure;

FIG. 5 illustrates how frame rate is controlled to synchronize the frame processing steps using the double buffers according to the teachings of the present disclosure; and

FIG. 6 is a listing of an embodiment of the frame rate control algorithm according to the teachings of the present disclosure.

### DETAILED DESCRIPTION

A primary challenge for cloud-based rendering for 3D applications stems from its reliance on shared powerful computing resources within the cloud infrastructure. Ensuring equitable resource allocation among users while maintaining performance and efficiency can be complex, especially during peak demand periods. Balancing energy consumption and efficiency while maintaining optimal user experience is vital. Users' game play experience is adversely impacted by latency, the delay between user input and the resulting visual feedback. High latency can lead to a disjointed and less optimal experience, making it challenging to achieve the real-time responsiveness required for interactive and VR applications. Hereinafter, the term 3D application is used to refer to graphics intensive real-time interactive applications such as VR applications.

Similar to traditional 3D applications, frame rate (expressed as frames per second or FPS) and motion-to-photon (MtP) latency are the main Quality of Service (QoS) metrics for cloud 3D applications. In ordinary usage scenarios, such as recreation and education, the Qos requirement usually demands that the frame rate is higher than a minimal FPS target value. The typical FPS target value is usually 30 or 60 FPS. For competitive gaming or VR applications, it is desirable that the frame rate be as high as possible. Typically, it is understood that the MtP latency should be less than 25 ms to avoid motion sickness, and for turn-based games, the maximum MtP latency can be around 1 second.

Because QoS is such an important metric for 3D applications, it has been the focus of the cloud industry. However, for cloud-based data centers, energy consumption and resource efficiency are equally important operational metrics.

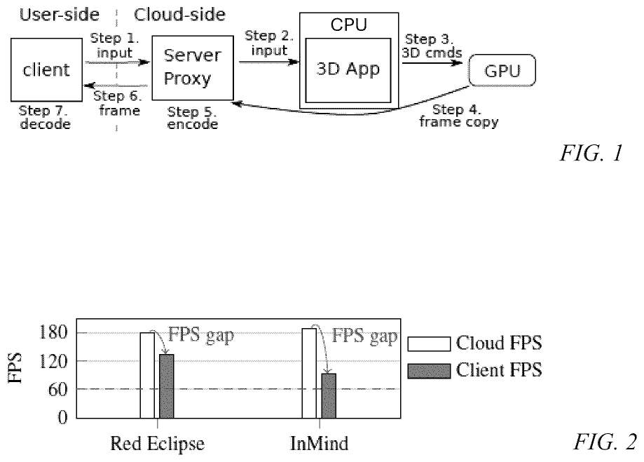

FIG. 1 is a simplified block diagram of a typical cloud 3D system where a 3D application is being executed in the cloud using cloud-based computing and storage resources such as a CPU (central processing unit) with multi-core processors and a GPU (graphics processing unit). The CPU executes instructions, performs calculations, and manages data processing tasks, while the GPU is tasked with functions related to graphics rendering and processing. The proxy server in the cloud acts as an intermediary between client devices and backend servers, facilitating communication and providing various services to improve security, performance, and scalability. As shown in FIG. 1, the client device, which may be any computing device such as a computer (e.g., key click, mouse click or movement), mobile device, or VR headset and/or gloves, receives a user input (e.g., user movements and gestures) via a user interface and transmits it, via one or more communication networks (e.g., the internet), to the 3D application residing and executing in a server (CPU) in the cloud. At cloud, the proxy server receives the input and forwards it to the 3D application. The 3D application processes this input and generates the corresponding 3D rendering commands for the virtual environment and visual elements, which are sent to the GPU to render. After the rendering is completed, the rendered frame is provided as a copy to the proxy server, which encodes the frame into a specific format suitable for streaming over the networks (e.g., H.264, H.265 (HEVC), and V P9) and transmits the encoded video frame to the client device through the network. Streaming protocols such as HTTP Live Streaming (HLS), Dynamic Adaptive Streaming over HTTP (DASH), or WebRTC are commonly used to deliver video content over the internet. These protocols dynamically adjust the bitrate and resolution of the video stream based on network conditions, ensuring optimal playback quality and minimizing buffering and latency. Upon receiving the streamed video frames, the user's VR headset or client device decodes the encoded data back into raw pixel information. The decoded frames are then displayed on the VR headset's screen, where the user can perceive them through the lenses of the headset. In addition to VR scene change in response to user input, the frame rendering process described above is also triggered by the 3D application's internal update/refresh commands.

Inefficiencies can be found in the execution of 3D applications in the cloud. FIG. 2 is a simplified diagram illustrating the not insignificant frame rate gap between what is provided by a state-of-the-art cloud data center and the rate of decoded frames at the client device. FIG. 2 shows two frame rates for two benchmarks, Red Eclipse and InMind, which are the frame rendering rate in the cloud (Cloud FPS) and the rate of the frames decoded at the client (Client FPS). One inefficiency comes from the large gap between the cloud and client FPS. In cloud 3D, frames rendered in the cloud are encoded and transmitted to the client, which are then decoded for the users to view and interact with. When the frames are rendered at a higher rate than the rate they can be encoded by the proxy server, transmitted over the networks, and/or decoded at the client device, these superfluous frames are discarded. This results in potentially wasted CPU/GPU cycles and energy. Another inefficiency comes from the excessively high FPS when compared to the FPS target. As shown in FIG. 2, both the cloud FPS and client FPS are higher than the conventional QoS requirement of 60 FPS (in red), again indicating that computing resources and energy that can be reallocated elsewhere instead of rendering the frames at a rate higher than needed.

This disclosure describes a FPS regulation scheme that provides on demand rendering (ODR) that is unlike conventional FPS regulation solutions where frame rates are controlled inside the 3D applications or in the GPU. The proposed novel ODR solution regulates frame rates inside the proxy server that is tasked with frame encoding and transmission. The proposed solution further uses two sets of double buffers to automatically synchronize the frame rendering, frame encoding, and frame transmission activities. Although the encoding frame rate in the proxy server may be slowed, updated frames that are rendered in response to user input are treated as priority frames that are not subject to any delay to help to optimize the user experience.

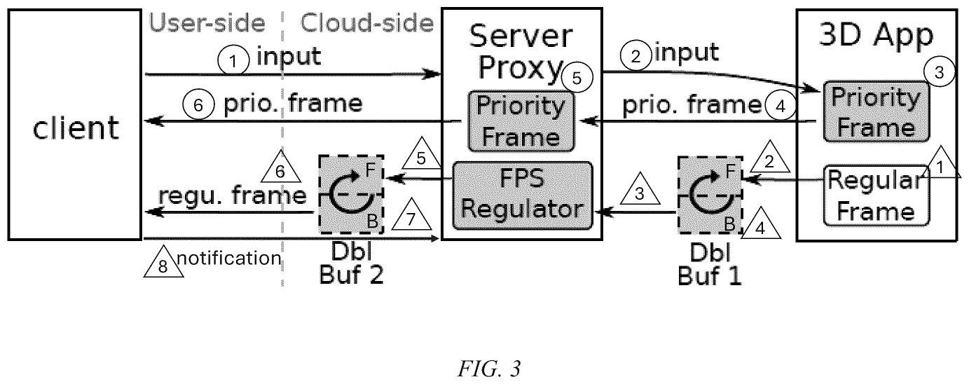

FIG. 3 is a simplified block diagram of an embodiment of a cloud 3D system with frame rate control and priority frame processing according to the teachings of the present disclosure. The cloud 3D system allows client devices to use cloud-based state-of-the-art computing resources to provide graphics rendering capabilities for VR and other resource-intensive applications. The client device can be any device having a user interface that can be manipulated by the user or can sense the user's movement and gestures as input. The cloud-based data center includes a proxy server that serves as the intermediary between the client device and the servers, with CPU and GPU resources. FIG. 3 illustrates two inventive concepts: FPS or frame rate control and priority frame processing.

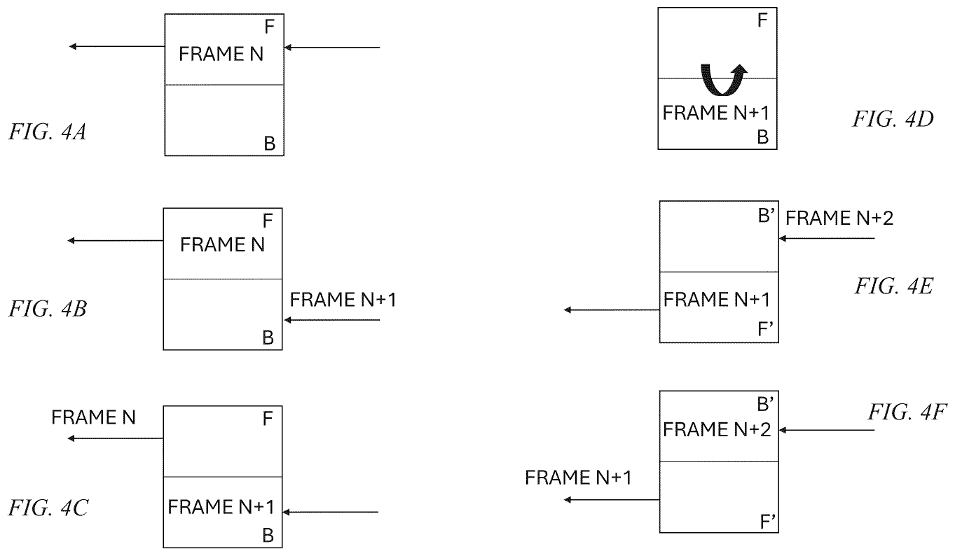

The proposed frame rate control reduces FPS gap that typically exists between the cloud frame rate and the client frame rate by synchronizing the frame processing steps and to quickly respond to changes. Referring to FIG. 3, two double-buffers are added: one between the 3D application and proxy server (double buffer 1 or Dbl Buf 1) and one between the proxy server and the network (double buffer 2 or Dbl Buf 2). Double buffer 1 is used to synchronize the frame rates between the 3D application and proxy server, and double buffer 2 is used to synchronize the frame rates between the proxy server and the network. Each double buffer has a front buffer (F) and a back buffer (B). Referring to the triangular numerals in FIG. 3, as the 3D application renders a frame (step 1), it is stored in the front buffer of double buffer 1 (step 2). As the current frame in the front buffer is being accessed and encoded by the proxy server (step 3), the next frame is rendered by the 3D application and stored in the back buffer of double buffer 1 (step 4). When the proxy server finishes encoding the frame from the front buffer, the encoded frame is transmitted to the front buffer of double buffer 2 (step 5). When the frame in the front buffer has been encoded and the back buffer contains the next frame from the 3D application, the proxy server treats the front and back buffers as back and front buffers, respectively, so that the front buffer is now the back buffer and the back buffer is now the front buffer. The place swap between the front and back buffers takes place only if the frame in the front buffer has been cleared from the buffer and encoded and the back buffer contains the next frame. The swapping is paused if the back buffer is empty when the 3D application is rendering the next frame slower than the encoding of the current frame by the proxy server. Similarly, the 3D application pauses rendering the next frame until the front and back buffers have traded spaces so that a new empty back buffer is available. The proxy server now accesses the copy of the next frame in the new front buffer to encode it, while the 3D application renders a newer frame and stores it in the new back buffer of double buffer 1. In this fashion, the frame rates of the 3D application and the proxy server are naturally synchronized. The second double buffer, double buffer 2, operates in a similar way. The proxy server stores the encoded frame into the front buffer (step 5), the network sends the encoded frame in the front buffer to the client (step 6), and the proxy server works on encoding the next frame (step 7). The proxy server or network pauses to wait for the slower one to clear or populate the buffers. The swapping of the front and back buffers takes place when a notification is received from the client device that the frame has been received. By using the double buffers in this manner, this scheme does not need to add explicit delays into any step of frame processing to reduce FPS gaps because the 3D application, proxy server, and the network naturally synchronize their frame rates based on the availability of the double buffer to receive the next frame. The length of the pauses is also automatically determined for each frame, allowing the frame rate to automatically adjust and adapt to fluctuations in frame processing time. FIGS. 4A-4F illustrate the double buffer swapping and synchronization method in more detail.

The FPS regulator residing in the proxy server is configured to delay and accelerate the frame copying and encoding operation of the proxy server to ensure that the frame rate meets the FPS target value. Using the two double buffers, once the encoding FPS matches the FPS target value, the rendering FPS and transmission FPS are naturally regulated to match the FPS target value as well.

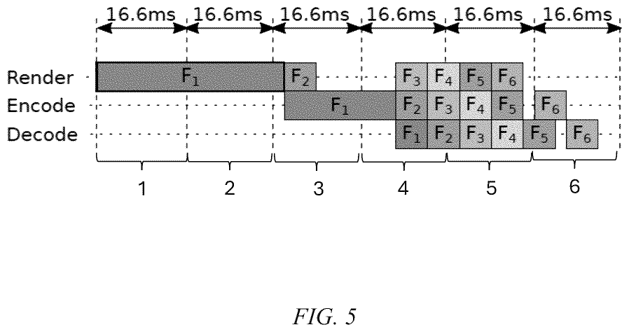

To address the low FPS issue caused by sudden-increase frame processing time, the FPS regulator accelerates the frame processing if it detects such an increase. This design is different than existing FPS regulation solutions that only delay the rendering step. When the FPS regulator detects that frame encoding rate does not meet the FPS target, it increases the encoding FPS to ensure the target is still met at the client device. The increased encoding FPS also increases the FPS of rendering and network transmission with the help of double buffering, allowing the whole 3D system to increase its throughput to meet the QoS target. For example, as shown in FIG. 5, when it is detected that only two frames (F1 and F2) are encoded within the first four intervals, it accelerates the encoding to output three frames (F3, F4 and F5) back to back. The faster encoding also accelerates the rendering through the double buffering. As a result, five frames are rendered/encoded over the span of five intervals, meeting the FPS target. For frame F6, as the FPS target has been met, its encoding is delayed to the beginning of the sixth interval so that the frame rate does not exceed the FPS target value.

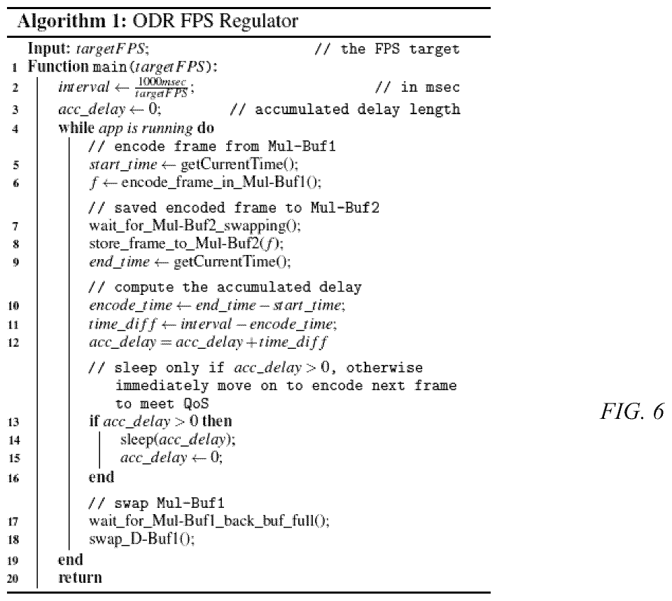

FIG. 6 shows an embodiment of the FPS regulator algorithm. The variable declared on line 3, acc_delay, is used to store the time that needs to be delayed to match the FPS target. The value of acc_delay is accumulated based on the processing time of previously encoded frames. During 3D application execution, the proxy server encodes a frame from the front buffer of Dbl-Buf1 (line 6) and stores the encoded frame to the back buffer of Dbl-Buf2 (line 9). The beginning and ending times of the encoding are recorded (line 5 and 9) to compute the encoding time for this frame (line 10). Then the difference (time_diff) between this encoding time and the expected encoding interval is computed (line 11), which is added to acc_delay (line 12). If time_diff is positive, the encoding time is faster than the expected interval. If time_diff is negative, the encoding time is slower than the expected interval. Similarly, if acc_delay is positive, then the encoding rate of past frames is faster than FPS target, and the encoding should be paused to slow down to meet the FPS target (line 13 to 16). However, if acc_delay is negative, then the current encoding FPS is smaller than the target FPS. In that case, the encoding should continue without delays until the FPS target is met and the acc_delay returns to positive. At the end of the FPS regulator algorithm, the front and back buffers of Dbl-Buf1 are swapped to start the rendering and encoding of the next frames (line 17 to 18).

This disclosure further describes a priority frame processing method used to reduce the MtP latency when FPS regulation is deployed to optimize the user experience. This method prioritizes those frames that are rendered in response to user input. The concept of priority frame processing is based on the observation that a majority of the frames rendered by an interactive 3D application are due to the application's automatic update or refresh instead of user input. A normal user typically only produces fewer than 250 actions/input per minute (APM). Even professional game players usually have an APM of only 300. Therefore, there are, on average, usually no more than five actions per second and no more than five user-input-generated frames per second. As there is only a small fraction of input-generated frames, it is possible to prioritize these frames to reduce MtP latency without significantly increasing the FPS gap or violate QoS requirements.

Referring back to FIG. 3, the concept of priority frame processing is illustrated using circled numerals. User input due to user's movement, action, and/or gestures are generated by the client device and transmitted via the network to the proxy server in the cloud (step 1). The proxy server forwards the user input to the 3D application (step 2). The 3D application treats the user input with priority and renders the user-input-generated frame without delay (step 3) and forwards the rendered frame to the proxy server, bypassing double buffer 1 (step 4). The proxy server may include a dedicated component to handle and encode the priority frame (step 5), and the encoded priority frame is then transmitted to the client device, bypassing double buffer 2 (step 6). To ensure a correct frame sequence, any unsent frames rendered before the input-generated frame are dropped. As there are only a few input-generated frames, these frame drops usually do not significantly increase FPS gaps.

To implement the ODR methodology described herein without having access to or altering the proprietary source code of the 3D applications, many of which are built with OpenGL and X Window, API hooks are used. More specifically, the glXSwap-Buffers API is part of the OpenGL (Open Graphics Library) extension for X Window System, which allows OpenGL applications to render graphics on X-based display servers. glXSwap-Buffers is a critical function for double-buffered rendering, a technique commonly used in OpenGL applications to prevent visual artifacts such as screen tearing. glXSwapBuffers is called at the end of the rendering of every frame to allow the GPU to finish processing 3D commands. Therefore, the delay of rendering can be inserted directly after the glXSwapBuffers. To delay rendering when the Dbl-Buf1 of the FPS regulator method is not-yet-swapped, glXSwap-Buffers intercepted.

To implement the priority frame processing scheme, the XNextEvent API from X Window is intercepted. XNextE vent is the standard X Window API to retrieve user inputs from the event queue. If the intercepted XNextE vent returns a user input, then priority frame cancels the rendering delay to prioritize and accelerate the processing of the user-input-generated frame.

It should be noted that the methods described in this disclosure are applicable to all real-time or near real-time interactive and graphics-intensive applications where graphics frames are rendered in the cloud and transmitted to a client device. These applications include augmented reality, virtual reality, and other similar applications.

### GLOSSARY

3D 3-Dimensional
CPU Central Processing Unit
FPS Frames Per Second
GPU Graphics Processing Unit
MtP Motion-to-Photon
VR Virtual Reality
ODR On Demand Rendering
OpenGL Open Graphics Library
QoS Quality of Service

The features of the present invention which are believed to be novel are set forth below with particularity in the appended claims. However, modifications, variations, and changes to the exemplary embodiments of the invention described above will be apparent to those skilled in the art, and the described herein thus encompasses such modifications, variations, and changes and are not limited to the specific embodiments described herein.

What is claimed is:

1. A computer-implemented method for regulating graphics frame rendering and encoding rates, comprising:
synchronizing a frame rate of rendering graphics frames by a 3D application executing in a cloud server with a frame rate of encoding rendered graphics frames at a proxy server; and
synchronizing the frame rate of encoding the rendered graphics frames at the proxy server with a frame rate of transmitting the encoded graphics frames to a client device over a network.

2. The computer-implemented method of claim 1, wherein synchronizing the rendering graphics frame rate with the encoding graphics frame rate comprises using a double buffer at the interface between the 3D application and the proxy server.

3. The computer-implemented method of claim 1, wherein synchronizing the encoding graphics frame rate with the transmitting graphics frame rate comprises using a double buffer at the interface between the proxy server and the network.

4. A computer-implemented method for regulating graphics frame rendering and encoding rates, comprising:
buffering a rendered graphics frame n from a 3D application executing in a cloud server and forwarding the buffered graphic frame n to a proxy server;
encoding the graphics frame n by the proxy server;
buffering the encoded graphics frame n from the proxy server;
transmitting the buffered encoded graphics frame n to a client device over a network;
buffering a next rendered graphics frame n+1 from the 3D application;
encoding the graphics frame n+1 by the proxy server;
buffering a next rendered graphics frame n+2 from the 3D application; and
transmitting the buffered encoded graphics frame n+1 to the client device over the network.

5. A computer-implemented method for regulating graphics frame rendering and encoding rates, comprising:
synchronizing graphics frame rendering at a 3D application executing in a cloud-based server and graphics frame encoding at a proxy server, comprising the steps of:
a. receiving a rendered graphics frame n from the 3D application and storing the received graphics frame in a front buffer of a first double buffer;
b. forwarding the received graphics frame n to the proxy server for encoding;
c. receiving a next rendered graphics frame n+1 from the 3D application and storing the received next graphics frame n+1 in a back buffer of the first double buffer;
d. swapping the front and back buffers of the first double buffer so that the front buffer is the new back buffer and the back buffer is the new front buffer;
e. receiving a next rendered graphics frame n+2 from the 3D application and storing the received next graphics frame n+2 in the new back buffer of the first double buffer; and
f. proceeding to step a; and
synchronizing graphics frame encoding at the proxy server and transmitting the encoded graphics frame to a client device over a network, comprising the steps of:
g. storing the encoded graphics frame n in a front buffer of a second double buffer;
h. transmitting the encoded graphics frame n to the client device over the network;
i. receiving the next encoded graphics frame n+1 from the proxy server and storing the received next graphics frame n+1 in a back buffer of the second double buffer;
j. swapping the front and back buffers of the second double buffer so that the front buffer is the new back buffer and the back buffer is the new front buffer;
k. receiving a next encoded graphics frame n+2 from the proxy server and storing the received next graphics frame n+2 in the new back buffer of the second double buffer; and
l. proceeding to step g.

6. The computer-implemented method of claim 1, further comprising:
recognizing the rendered graphics frame n received from the 3D application is in response to a user input;
prioritizing the received rendered graphics frame n and forwarding the prioritized rendered graphics frame n to the proxy server, bypassing the first double buffer;
encoding the prioritized graphics frame n; and
transmitting the encoded prioritized graphics frame n to the client device, bypassing the second double buffer.

7. A computer-implemented method to prioritize certain graphics frames rendered by a 3D application, comprising:
recognizing at least one rendered graphics frame received from the 3D application is generated in response to a user input received from a client device;
prioritizing the at least one received rendered graphics frame and forwarding the at least one prioritized rendered graphics frame to a proxy server without delay;
encoding the at least one prioritized graphics frame without delay; and
transmitting the at least one encoded prioritized graphics frame to the client device without delay.
